(19) United States
(12) Patent Application Publication
(10) Pub. No.: US 2009/0089676 A1
(43) Pub. Date: Apr. 2, 2009

(54) Tabbed Multimedia Navigation

(75) Inventors: Jeff Finkelstein, San Francisco, CA (US); Richard Sagar, San Jose, CA (US); Jeff Hawkins, Atherton, CA (US); David Berkowitz, Palo Alto, CA (US); Steve Doss, San Carlos, CA (US); Justin Kodama, East Palo Alto, CA (US); Pieter van der Meulen, Los Altos, CA (US); Kam Stewart, San Mateo, CA (US); Matt Crowley, Los Altos, CA (US); Rich Dellinger, San Jose, CA (US)

Correspondence Address: KACVINSKY LLC;4500 BROOKTREE ROAD, SUITE 102, WEXFORD, PA, 15090, US

(73) Assignee: PALM, INC., Sunnyvale, CA (US)

(21) Appl. No.: 11/865,056

(22) Filed: Sep. 30, 2007

(51) Int. Cl. G06F 3/048

(52) U.S. Cl. 715/719; 715/716

(57) ABSTRACT

Various embodiments are directed to improved systems and techniques for allowing a user to navigate to media content on a mobile computing device and/or perform available operations associated with the media content. In one embodiment, for example, a mobile computing device may comprise a display to present a tabbed multimedia graphical user interface comprising a navigation bar including a plurality of navigation tabs for navigating to media content and performing available operations associated with the media content. The plurality of navigation tabs may comprise an audio navigation tab associated with audio content, a pictures and videos navigation tab associated with image and video content, a still camera navigation tab for taking digital photographs, a video camera navigation tab for taking video movies, and an online and bookmarks navigation tab associated with online media content. The tabbed multimedia graphical user interface may present a corresponding view associated with an active navigation tab. Tapping a different navigation tab on the display or inputting a directional command to the mobile computing device may immediately navigate to the different navigation tab and display the corresponding view for enabling a user to navigate to media content and perform available operations associated with the different navigation tab.

### RELATED APPLICATIONS

This application is related to co-pending and commonly assigned U.S. patent application Ser. No. 11/469,969 titled User Interface for a Wireless Device, which was filed on Sep. 5, 2006 and is incorporated by reference in its entirety.

### BACKGROUND

A mobile computing device such as a combination handheld computer and mobile telephone or smart phone generally may provide voice and data communications functionality as well as computing and processing capabilities. The mobile computing device may incorporate features such as a color display screen, a digital camera, Web access, and multimedia capability. The mobile computing device also may run a variety of applications for storing, accessing, and displaying information to a user.

When running an application, the mobile computing device typically presents the user with a system of graphical user interfaces for enabling the user to interact with the application and to perform operations and functions available to the user. The user may interact with the application through the graphical user interfaces by tapping touch-sensitive portions of the display screen as well as by pushing certain keys and buttons on the mobile computing device.

In general, mobile computing devices require a considerable amount of user interaction to navigate through various graphical user interfaces in order to achieve a certain result or to display desired information. Accordingly, improved systems and techniques for graphical user interface navigation are needed.

### BRIEF DESCRIPTION OF THE DRAWINGS

FIG. 1 illustrates one embodiment of a mobile computing device.

FIG. 2 illustrates one embodiment of a communications system comprising multiple media sources.

FIG. 3 illustrates one embodiment of a mobile computing device.

FIG. 4 illustrates a tabbed multimedia navigation architecture in accordance with various embodiments.

FIGS. 5-9 illustrate tabbed multimedia graphical user interfaces in accordance with various embodiments.

FIG. 10 illustrates a logic flow in accordance with various embodiments.

### DETAILED DESCRIPTION

Various embodiments are directed to improved systems and techniques for allowing a user to navigate to media content on a mobile computing device and/or perform available operations associated with the media content. In one embodiment, for example, a mobile computing device may comprise a display to present a tabbed multimedia graphical user interface comprising a navigation bar including a plurality of navigation tabs for navigating to media content and performing available operations associated with the media content. The plurality of navigation tabs may comprise an audio navigation tab associated with audio content, a pictures and videos navigation tab associated with image and video content, a still camera navigation tab for taking digital photographs, a video camera navigation tab for taking video movies, and an online and bookmarks navigation tab associated with online media content.

The tabbed multimedia graphical user interface may present a corresponding view associated with an active navigation tab. Tapping a different navigation tab on the display or inputting a directional command to the mobile computing device may immediately navigate to the different navigation tab and display the corresponding view for enabling a user to navigate to media content and perform available operations associated with the different navigation tab.

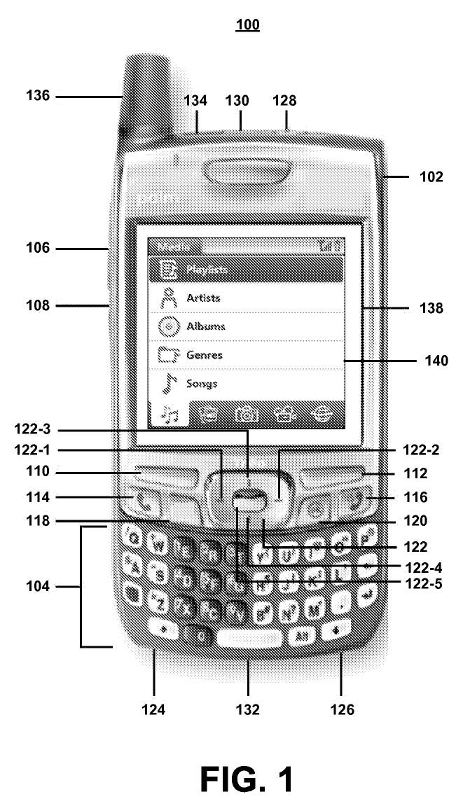

FIG. 1 illustrates one embodiment of a mobile computing device 100. Mobile computing device 100 may comprise or be implemented as a combination handheld computer and mobile telephone or smart phone such as a Palm® Treo™ smart phone. Although some embodiments may be described with mobile computing device 100 implemented as a smart phone by way of example, it may be appreciated that mobile computing device 100 may be implemented as other types of wireless computing devices having voice and/or data communications functionality such as a handheld device, personal digital assistant (PDA), mobile telephone, combination mobile telephone/PDA, mobile unit, subscriber station, game device, messaging device, media player, pager, or any other suitable communications device in accordance with the described embodiments.

Mobile computing device 100 may comprise a housing 102 encapsulating various internal components such as a printed circuit board (PCB), internal antennas, a removable and rechargeable battery (e.g., lithium ion battery), as well as one or more processors (e.g., host processor, radio processor, modem processor, baseband processor), memory (e.g., volatile or non-volatile memory, removable or non-removable memory, erasable or non-erasable memory, writeable or re-writeable memory), transceivers (e.g., voice communications transceiver, data communications transceiver, GPS transceiver), and others. Housing 102 may be formed from materials such as plastic, metal, ceramic, glass, and others which are suitable for enclosing and protecting the internal components of mobile computing device 100.

Mobile computing device 100 may comprise various input/output (I/O) devices such as a keyboard, keys, buttons, switches, a microphone, speakers, an audio headset, a camera, a touch-sensitive display screen, a stylus, and so forth. As shown in FIG. 1, mobile computing device 100 may comprise an alphanumeric keyboard 104 having a QWERTY key layout and an integrated number dial pad. Mobile computing device 100 may comprise various buttons such as, for example, a volume button 106, a customizable button 108, a left action button 110, a right action button 112, a phone/send button 114, a power/end button 116, a start button 118, an OK button 120, and a navigation button 122.

Navigation button 122 may be used to input navigation information from the user corresponding to left, right, up, down, and select commands. As shown, navigation button 122 may comprise left key 122-1, right key 122-2, up key 122-3, down key 122-4, and center (select) key 122-5 which when actuated implement multi-directional navigation functionality. In various embodiments, such commands may be input by the user to navigate among and within various graphical user interfaces and/or to select available functions or menu items displayed to a user. It is to be appreciated that multi-directional navigation functionality may be implemented using elements other than navigation button 122, such as a 4-, 5-, or 8-way multi-directional touch pad, a joystick, an accelerometer for detecting directional commands, soft keys, and/or any other type of navigation elements in accordance with the described embodiments.

Mobile computing device 100 may comprise an audio port 124 to connect an audio headset, a microphone 126, and a ringer on/off switch 128 having a vibrate mode. Mobile computing device 100 also may comprise an expansion slot 130 to support a memory card such as a secure digital (SD) card, multimedia memory card (MMC), and/or any other type of storage card in accordance with the described embodiments.

Mobile computing device 100 may comprise an antenna system implemented by one or more internal antennas (not shown) and/or external antennas, such as a stub antenna 136. In various embodiments, the antenna system may comprise one or more internal and/or external antennas tuned for operating at one or more frequency bands. This may be desirable since mobile computing device 100 may be compatible with multiple wireless data, multimedia, and/or cellular telephone networks or systems.

Mobile computing device 100 may comprise a display 138 implemented by a LCD or other type of suitable visual interface. Display 138 may comprise, for example, a touch-sensitive color (e.g., 16-bit color) display screen such as a thin-film transistor (TFT) LCD. As shown, display 138 may be arranged to present a graphical user interface (GUI) 140 to a user. In various embodiments, GUI 140 may comprise a tabbed multimedia user interface for enabling a user to navigate to media content on mobile computing device 100 and/or perform available operations associated with the media content. The media content may comprise, for example, image information, audio information, video information, and/or audio/visual (A/V) information from a media source. Media content may comprise static or streaming information and may be stored locally on mobile computing device 100 and/or a memory card (e.g., SD card, MMC, etc.) or may be stored remotely on a server or other media device.

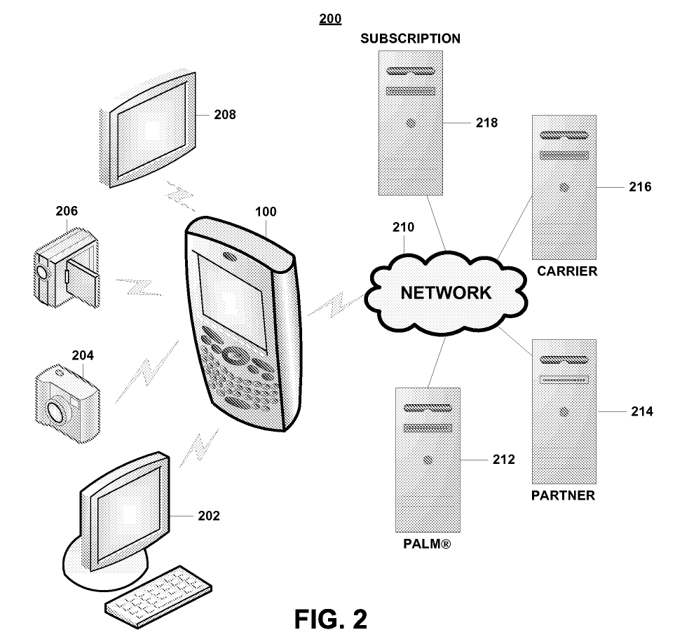

FIG. 2 illustrates one embodiment of a communications system 200 comprising multiple media sources. In general, a media source may comprise any source capable of delivering static or dynamic media content to mobile computing device 100. In some embodiments, a media source may be implemented by mobile computing device 100. For example, mobile computing device 100 may comprise an integrated camera enabling a user to take still digital photographs and/or video movies. In other embodiments, a media source may be implemented by various local and/or remote devices capable of delivering media content to mobile computing device 100. Although FIG. 2 includes a limited number of elements for purposes of illustration, it can be appreciated that communications system 200 may include more or less elements as well as other types of elements in accordance with the described embodiments.

In various embodiments, mobile computing device 100 may be arranged to provide voice and data communications functionality. For example, mobile computing device 100 may provide voice communications functionality in accordance with one or more cellular telephone networks or systems. Examples of cellular telephone networks or systems may include Code Division Multiple Access (CDMA), Global System for Mobile Communications (GSM), North American Digital Cellular (NADC), Time Division Multiple Access (TDMA), Extended-TDMA (E-TDMA), Narrowband Advanced Mobile Phone Service (NAMPS), third generation (3G) networks or systems such as Wide-band CDMA (WCDMA), CDMA-2000, Universal Mobile Telephone System (UMTS), and others.

In addition to voice communications functionality, mobile computing device 100 may provide wireless wide area network (WWAN) data communications functionality including Internet access in accordance with one or more cellular telephone networks or systems. Examples of cellular telephone networks or systems offering WWAN data communications services may include Evolution-Data Optimized or Evolution-Data only (EV-DO), Evolution For Data and Voice (EV-DV), CDMA/1xRTT, GSM with General Packet Radio Service systems (GSM/GPRS), Enhanced Data Rates for Global Evolution (EDGE), High Speed Downlink Packet Access (HSDPA), High Speed Uplink Packet Access (HSUPA), and others.

Mobile computing device 100 also may be arranged to provide data communications functionality in accordance with various types of wireless local area network (WLAN) systems. Examples of suitable WLAN systems offering data communications services may include the Institute of Electrical and Electronics Engineers (IEEE) 802.xx series of protocols, such as the IEEE 802.1 a/b/g/n series of standard protocols and variants (also referred to as “WiFi”), the IEEE 802.16 series of standard protocols and variants (also referred to as “WiMAX”), the IEEE 802.20 series of standard protocols and variants, and others.

Mobile computing device 100 may be arranged to perform data communications functionality in accordance with various types of shorter range wireless networks or systems, such as a wireless personal area network (PAN) offering Bluetooth® data communications services in accordance with the Bluetooth® Special Interest Group (SIG) series of protocols, specifications, profiles, and so forth. Other examples of shorter range wireless networks or systems may employ infrared (IR) techniques or near-field communication techniques and protocols, such as electro-magnetic induction (EMI) techniques. Exemplary EMI techniques may include passive or active radio-frequency identification (RFID) protocols and devices.

In some cases, mobile computing device 100 may be implemented as a multi-band wireless device supporting operation in multiple frequency bands. For example, mobile computing device 100 may be arranged to operate in various frequency bands or sub-bands such as the 2.4 GHz range of the ISM frequency band for WiFi and Bluetooth® communications, one or more of the 850 MHz, 900 MHZ, 1800 MHz, and 1900 MHz frequency bands for GSM, CDMA, TDMA, NAMPS, cellular, and/or PCS communications, the 2100 MHz frequency band for CDMA2000/EV-DO and/or WCDMA/UMTS communications, the 1575 MHz frequency band for Global Positioning System (GPS) operations, and other frequency bands.

In some embodiments, mobile computing device 100 may communicate over a wired (e.g., USB) or wireless (e.g., WiFi, Bluetooth®, IR) connection to receive media content from a local device such as personal computer (PC) 202, digital camera 204, video camera 206, and/or other media device such as television (TV) 208. Although PC 202, digital camera 204, video camera 206, and TV 208 are shown for purposes of illustration, it can be appreciated that mobile computing device 100 may receive media content from other local devices such as a laptop computer, handheld device, PDA, mobile telephone, combination mobile telephone/PDA, mobile unit, subscriber station, user terminal, portable computing device, game device, messaging device, pager, data communication device, media player, media appliance, set-top box (STB) device, digital TV (DTV) device, high-definition TV (HDTV) device, direct broadcast satellite TV (DBS) device, video on-demand (VOD) device, Internet Protocol TV (IPTV) device, Web TV device, digital video recorder (DVR) device, digital versatile disc (DVD) device, high-definition DVD (HD-DVD) device, Blu-ray disc (BD) device, video home system (VHS) device, digital VHS device, entertainment system, audio/video (A/V) receiver, or other suitable media devices.

In some embodiments, mobile computing device 100 may communicate over a network 210 to receive media content from one or more remote devices. For example, mobile computing device 100 may be arranged to receive media content through network 210 in accordance with one or more WWAN data communication services such as one or more cellular data communication services (e.g., GSM/GPRS, CDMA/1xRTT, EDGE, EVDO, EV-DV, HSDPA, etc.). In general, mobile computing device 100 may receive and store media content received over network 210 for access and display by a user. It can be appreciated that mobile computing device 100 also may be arranged to transfer media content received over network 210 to one or more local devices (e.g., PC 202, TV 208, another mobile computing device, printer, etc.) for storage, display, and/or printing.

When communicating over network 210, mobile computing device 100 may receive media content from various remote devices such as one or more media servers capable of uploading and downloading static or streaming media content. Mobile computing device 100 may be used to download media content (e.g., songs, ring tones, pictures, videos) from and/or upload media content to a media server. In some cases, a user may subscribe to receive media content to be delivered from a media server as a Really Simple Syndication (RSS) document, podcast, blog entry, Web feed, and so forth.

As shown in FIG. 2, exemplary media servers may include, without limitation, a mobile computing device server 212 hosted by and/or associated with the manufacturer of mobile computing device 100, an affiliate or partner server 214 hosted by and/or associated with an entity having a business relationship with the manufacturer of mobile computing device 100, a carrier server 214 hosted by and/or associated with the communications services carrier for mobile computing device 100, a subscription server 218 hosted by and/or associated with a provider of one or more media services for which the user of mobile computing device 100 has subscribed, or any other type of remote media source in accordance with the described embodiments.

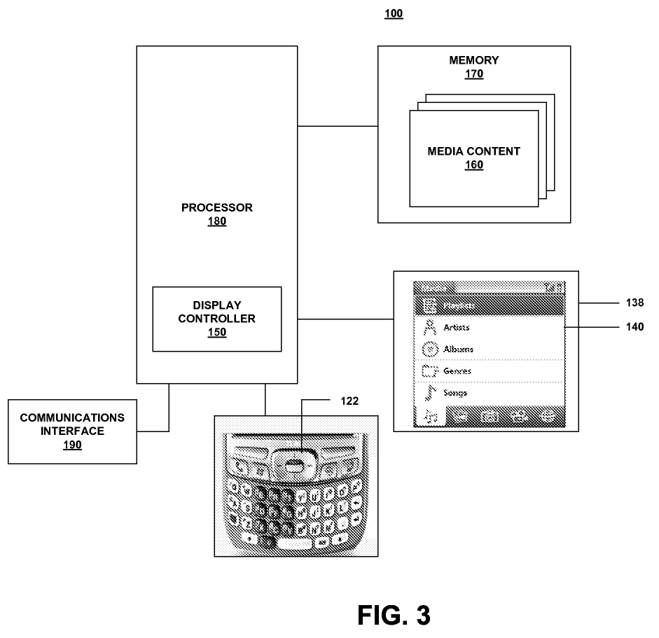

FIG. 3 illustrates one embodiment of mobile computing device 100. The mobile computing device 100 generally may comprise various physical or logical elements implemented as hardware, software, or any combination thereof, as desired for a given set of design parameters or performance constraints. The physical or logical elements may be connected by one or more types of communications media including wired communication media, wireless communication media, or a combination of both, as desired for a given implementation.

As shown, mobile computing device 100 may include a touch-sensitive display 138 to present GUI 140 comprising a tabbed multimedia user interface for enabling a user to navigate to media content on mobile computing device 100 and/or perform available operations associated with the media content. Mobile computing device 100 also may comprise navigation button 122 to input navigation information from the user corresponding to left, right, up, down, and select commands. In various embodiments, such commands may be input by the user to navigate among and within a system of tabbed multimedia graphical user interfaces including GUI 140.

Mobile computing device 100 may comprise a display controller 150 to retrieve and process media content 160 stored in memory 170. Display controller 150 may comprise or be implemented as hardware, software, or any combination thereof. In some embodiments, for example, display controller 150 may comprise one or more processors, controllers, encoder devices, decoder devices, CODEC devices, scaling devices, filters, converters, circuits, chips, logic devices, logic gates, switches, registers, semiconductor devices, transistors, or combination thereof. In some embodiments, for example, display controller 150 may comprise software implemented by one or more applications (e.g., audio player, image viewer, multimedia player, media management, digital camera, video camera, Web browser, etc.), drivers, programs, modules, subroutines, instruction sets, instructions, computing codes, or combination thereof.

Media content 160 may comprise various types of media information such as image information, audio information, video information, and/or audio/visual (A/V) information from a media source. In various embodiments, media content 160 may comprise data derived from or associated with one or more images, image files, image groups, pictures, digital photographs, albums, songs, music, sounds, ring tones, audio clips, audio files, audio sequences, audio feeds, audio streams, movies, videos, video clips, video files, video sequences, video feeds, video streams, broadcast programming, Web pages, graphics, games, regions, objects, frames, slices, macroblocks, blocks, pixels, sub-pixels, signals, and others.

Memory 170 may comprise various types of computer-readable storage media capable of storing data such as volatile or non-volatile memory, removable or non-removable memory, erasable or non-erasable memory, writeable or re-writeable memory, and so forth. It can be appreciated that memory 170 may be implemented by computer-readable storage media internal to mobile computer device 100 or by computer-readable storage media external to or removable from mobile computing device 100 such as memory card (e.g., SD card, MMC, etc.). In some embodiments, media content 160 may be stored and arranged in memory 170 within one or more databases, tables, regions, or buffers according to information type, media source, default settings, user-configured settings, and other parameters.

Mobile computing device 100 may comprise a processor module 180 including one or more processors for performing operations in accordance with the described embodiments such as presenting various GUIs, detecting user inputs, running media applications, and so forth. Examples of a processor may include, without limitation, a central processing unit (CPU), general purpose processor, dedicated processor, chip multiprocessor (CMP), media processor, digital signal processor (DSP), microprocessor, controller, microcontroller, application specific integrated circuit (ASIC), field programmable gate array (FPGA), programmable logic device (PLD), or other suitable processing device in accordance with the described embodiments.

Processor module 180 may be arranged to run an operating system (OS) and various mobile applications. Examples of an OS include, for example, a Palm OS®, a Microsoft® Windows OS, and any other proprietary or open source OS. Examples of mobile applications include, for example, a telephone application, messaging applications (e.g., e-mail, instant messaging, short message service, multimedia message service, video conferencing), browser application, personal information management (PIM) applications (e.g., contacts, calendar, scheduling, tasks), word processing applications, spreadsheet applications, database applications, camera (e.g., digital camera, video camera) application, media applications (e.g., audio player, image viewer, multimedia player, media management), gaming applications, and so forth.

In some embodiments, processor module 180 may implement display controller 150. For example, in some cases, display controller 150 may comprise software implemented by processor module 180. It also can be appreciated that while memory 170 may be shown as being separate from processor module 180, in some implementations, a portion of or the entirety of memory 170 may be included on the same integrated circuit as a processor within processor module 180.

Mobile computing device 100 may comprise a communications interface 190 for receiving and sending media content. Communications interface 190 may comprises any suitable hardware, software, or combination capable of coupling mobile computing device 100 to one or more networks and/or devices. Communications interface 190 may comprise one or more interfaces such as, for example, a wireless communications interface, a wired communications interface, a network interface, a transmit interface, a receive interface, a media interface, a system interface, a component interface, a switching interface, a chip interface, a controller, and so forth. Communications interface 190 may be arranged to operate with any suitable technique for controlling information signals using a desired set of communications protocols, services or operating procedures and may include the appropriate physical connectors to connect with a corresponding communications medium.

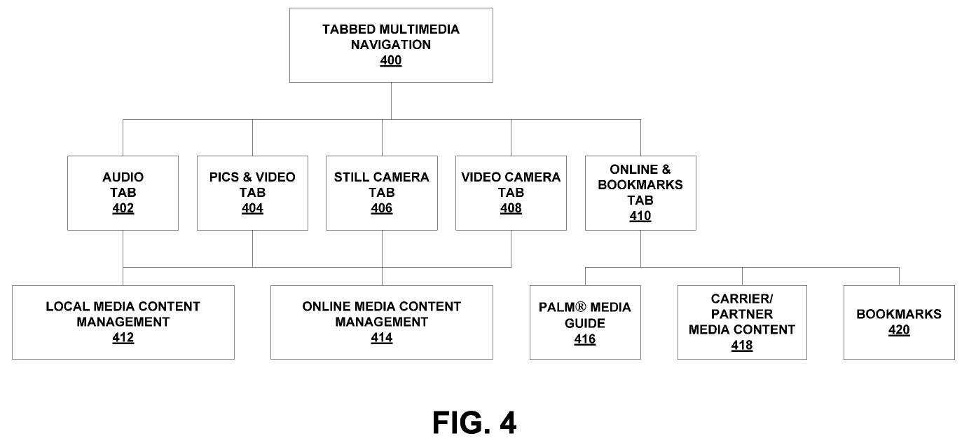

FIG. 4 illustrates a tabbed multimedia navigation architecture 400 in accordance with various embodiments. As illustrated, tabbed multimedia navigation architecture 400 may comprise or implement a plurality of functional units or modules. Each functional unit or module may comprise hardware and/or software for performing one or more operations in accordance with the described embodiments. For example, a module may comprise a computing device arranged to execute program instructions implemented as software, code, and/or firmware. A module also may comprise executable program instructions and/or one or more types of computer-readable storage media capable of storing executable computer program instructions that when executed by a computing device result in the performance of various operations in accordance with the described embodiments.

Tabbed multimedia navigation architecture 400 may be implemented by mobile computing device 100 to enable a user to navigate to media content and/or perform available operations associated with media content. In one exemplary embodiment, tabbed multimedia architecture 400 may comprise an audio tab module 402, a pictures and videos tab module 404, a still camera tab module 406, a video camera tab module 408, and an online and bookmarks tab module 410.

Audio tab module 402 may be arranged to provide various functions associated with audio content. For example, audio tab module 402 may provide functions for enabling a user to manage, browse, and play audio content. As shown, audio tab module 402 may cooperate with a local media content management module 412 for navigating to and/or performing operations associated with audio content stored locally on mobile computing device 100 and/or a memory card (e.g., SD card, MMC, etc.). Audio tab module 402 also may cooperate with a remote media management module 414 for navigating to and/or performing operations associated with online audio content stored remotely on server or other media device. Audio tab module 402 may operate in conjunction with an audio player application for playing audio content using mobile computing device 100. Audio tab module 402 also may operate in conjunction with one or more communication applications to allow a user to upload/download audio content, manage audio content online, and/or transfer audio content to and from a local device.

Pictures and videos tab module 404 may be arranged to provide various functions associated with image and video content. For example, pictures and video tab module 404 may provide functions for enabling a user to manage, browse, and display image and/or video content. As shown, pictures and videos tab module 404 may cooperate with local media content management module 412 for navigating to and/or performing operations associated with image and video content stored locally on mobile computing device 100 and/or a memory card (e.g., SD card, MMC, etc.). Pictures and videos tab module 404 also may cooperate with remote media management module 414 for navigating to and/or performing operations associated with online image and video content stored remotely on server or other media device.

Pictures and videos tab module 404 may operate in conjunction with a viewer application and a video player application to allow a user to scroll through, find, and display image and video content using mobile computing device 100. Pictures and videos tab module 404 also may operate in conjunction with one or more communication applications to allow a user to share image and video content with other users (e.g., via e-mail, MMS, IM, etc.), upload/download image and video content, and/or manage image and video content online. A user also may transfer image and video content to and from a local device (e.g., PC 202) for archiving and accessing digital photographs and video in designated desktop folders.

Still camera tab module 406 may be arranged to provide various functions associated with taking digital photographs, and video camera tab module 408 may be arranged to various functions associated with taking video movies. Still camera tab module 406 and video camera module 408 may operate in conjunction with a camera application to allow a user to create digital photographs and video movies using mobile computing device 100. As shown, still camera tab module 406 and video camera module 408 may cooperate with local media content management module 412 to create and store image and video content locally on mobile computing device 100 and/or a memory card (e.g., SD card, MMC, etc.). Still camera tab module 406 and video camera tab module 408 also may cooperate with remote media management module 414 for creating and remotely storing image and video content online.

Online and bookmarks tab module 410 may be arranged to provide various functions associated with online media content. For example, online and bookmarks tab module 410 may provide functions for enabling a user to manage, browse, and display online content available through a variety of online media channels and/or services. Exemplary online media channels and/or services may include, without limitation, audio and/or video streaming, audio downloads for ring tones and/or music, picture and/or video downloads, audio and/or video podcasts, online communities for sharing media content, Web video searching and sharing, digital photograph searching and sharing, Internet radio and/or television stations, RSS feeds, blogs, and others.

As shown, online and bookmarks tab module 410 may cooperate with a media guide module 416 for navigating to and/or performing operations associated with one or more online media services provided by and/or associated with the manufacturer of mobile computing device 100. Online and bookmarks tab module 410 also may cooperate with a carrier/partner media content module 418 for navigating to and/or performing operations associated with one or more online media services provided by and/or associated with an entity having a business relationship with the manufacturer of mobile computing device 100 and/or the communications services carrier for mobile computing device 100. Online and bookmarks tab module 410 also may cooperate with a bookmarks module 420 for navigating to and/or performing operations associated with one or more online media services subscribed to by the user of mobile computing device 100 and/or designated by the user as a favorite.

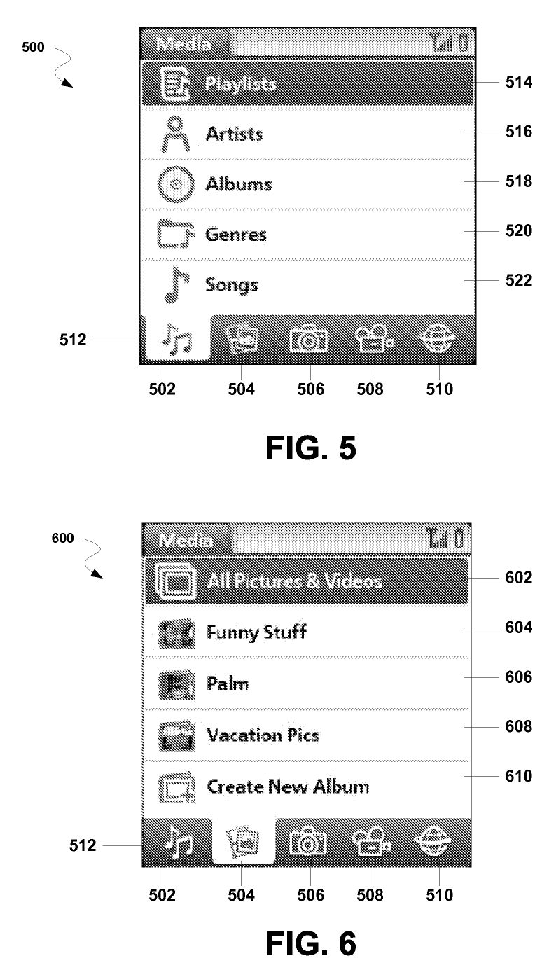

FIG. 5 illustrates one embodiment of a tabbed multimedia GUI 500. In various embodiments, tabbed multimedia GUI 500 may be implemented by mobile computing device 100 to enable a user to navigate to media content and/or perform available operations associated with media content. In one exemplary embodiment, tabbed multimedia GUI 500 may comprise a plurality of navigation tabs including an audio navigation tab 502, a pictures and videos navigation tab 504, a still camera navigation tab 506, a video camera navigation tab 508, and an online and bookmarks navigation tab 510.

As shown, the plurality of navigation tabs may be implemented by a navigation bar 512 located at the bottom of GUI 500. In general, when a particular navigation tab from navigation bar 512 is selected or active, a corresponding view is presented which is associated with the particular navigation tab. Navigation bar 512 allows the user to quickly navigate to media content and/or functions associated with other navigation tabs by tapping a different navigation tab and/or by inputting directional commands. In some implementations, tapping a different navigation tab and/or inputting a left or right command immediately navigates to the different (e.g., tapped, previous or next) navigation tab and presents the corresponding view to enable a user to quickly navigate to and/or perform available operations associated with other types of media content. In other implementations, additional input of a select command (e.g., via center key 122-5) may be required to navigate away from one navigation tab and to another.

In this embodiment, left and right commands may be dedicated for navigation among the navigation tabs. For example, input of a left command (e.g., via left key 122-1) may navigate to a previous navigation tab, and input of a right command (e.g., via right key 122-2) may navigate to a next navigation tab. Cycling may be enabled such that input of a right command when at the far right navigation tab (e.g., online and bookmarks tab 510) will navigate to the far left navigation tab (e.g., audio tab 502) and input of a left command when at the far left navigation tab (e.g., audio tab 502) will navigate to the far right navigation tab (e.g., online and bookmarks tab 510).

In this embodiment, up and down commands may be dedicated for navigation within an active navigation tab. For example, input of an up command (e.g., via up key 122-3) may move to a previous menu item, and input of a down command (e.g., via down key 122-4) may move to a next menu item. Cycling may be enabled such that input of a down command when at the bottom menu item loops back to the top menu item and input of an up command when at the top menu item loops back to the bottom menu item. In various implementations, tapping a menu item on the display and/or inputting a select command (e.g., via center key 122-5) chooses a selected menu item.

When a particular navigation tab is selected or active, a corresponding view is presented which may include menu items associated with the particular navigation tab. In FIG. 5, audio navigation tab 502 is selected or active. Accordingly, tabbed multimedia GUI 500 includes various menu items for navigating to audio content and/or performing available operations associated with audio content. In one exemplary embodiment, tabbed multimedia GUI 500 displays a playlists menu item 514, a genres menu item 516, an artists menu item 518, an albums menu item 520, and a songs menu item 522.

When playlists menu item 514 is selected, audio content may be displayed in a subsequent GUI according to one or more user-defined playlists. A user may scroll through the playlists and select a playlist which, in turn, displays another GUI allowing the user to scroll through and select a song within a selected playlist. After scrolling through and selecting a particular song, the user may play the selected song using an audio player application implemented by mobile computing device 100. In some embodiments, each subsequent GUI may comprise navigation bar 512 to allow the user to quickly navigate to media content and/or functions associated with other navigation tabs.

It can be appreciated that similar operations may be performed when selecting genres menu item 516 to display audio content by music genre, artists menu item 518 to display audio content according to artist, albums menu item 520 to display audio content by album, and songs menu item 522 to display audio content by song.

FIG. 6 illustrates one embodiment of a tabbed multimedia GUI 600. In various embodiments, tabbed multimedia GUI 600 may be implemented by mobile computing device 100 to enable a user to navigate to media content and/or perform available operations associated with media content. In one exemplary embodiment, tabbed multimedia GUI 600 may comprise a plurality of navigation tabs including an audio navigation tab 502, a pictures and videos navigation tab 504, a still camera navigation tab 506, a video camera navigation tab 508, and an online and bookmarks navigation tab 510.

As shown, the plurality of navigation tabs may be implemented by a navigation bar 512 located at the bottom of GUI 600. When a particular navigation tab from navigation bar 512 is selected or active, a corresponding view is presented which is associated with the particular navigation tab. Navigation bar 512 allows the user to quickly navigate to media content and/or functions associated with other navigation tabs by tapping a different navigation tab and/or by inputting directional commands.

In FIG. 6, pictures and videos navigation tab 504 is selected or active. Accordingly, tabbed multimedia GUI 600 displays various menu items for navigating to and/or performing available operations associated with image and video content. In one exemplary embodiment, tabbed multimedia GUI 600 displays an all pictures and videos menu item 602, a first album menu item 604, a second album menu item 606, a third album menu item 608, and a create new album menu item 610. In various implementations, some albums may be promoted to the top level view in GUI 600 when other menu items are not present and/or in place of other menu items. In some embodiments, each subsequent GUI presented after selection of a particular menu item also may comprise navigation bar 512 to allow the user to quickly navigate to media content and/or functions associated with other navigation tabs.

When all pictures and videos menu item 602 is selected, image and video content may be displayed in a subsequent GUI allowing a user to scroll through thumbnails of digital photographs and video movies and to select a particular image or video for display. After making a selection, the user may display selected digital photographs as full-screen images and/or a slideshow using a viewer application and may play selected videos using a video player application. A user may share image and video content with other users (e.g., via e-mail, MMS, IM, etc.), upload/download image and video content, and/or manage image and video content online. A user also may transfer image and video content to and from a local device, such as PC 202, for archiving and accessing digital photographs and video in designated folders located on PC 202.

When an album menu item (e.g., first album menu item 604, second album menu item 606, or third album menu item 608) is selected, image and video content from the particular album may be displayed in a subsequent GUI allowing a user to scroll through thumbnails of digital photographs and video movies and to select a particular image or video from within the album. After making a selection, the user may display, share, upload/download, transfer, and/or manage the image and video content. It is noted that selection of first album menu item 604, second album menu item 606, or third album menu item 608 may enable access to image and video content stored locally on mobile computing device 100 and/or a memory card (e.g., SD card, MMC, etc.) as well as access to online image and video content stored remotely on server or other media device.

When create new album menu item 610 is selected, image and video content may be displayed in a subsequent GUI allowing a user to scroll through and select particular thumbnails of digital photographs and video movies for inclusion in a new album. It is noted that the new album may store image and video content locally on mobile computing device 100 and/or a memory card (e.g., SD card, MMC, etc.) as well as remotely on a server or other media device.

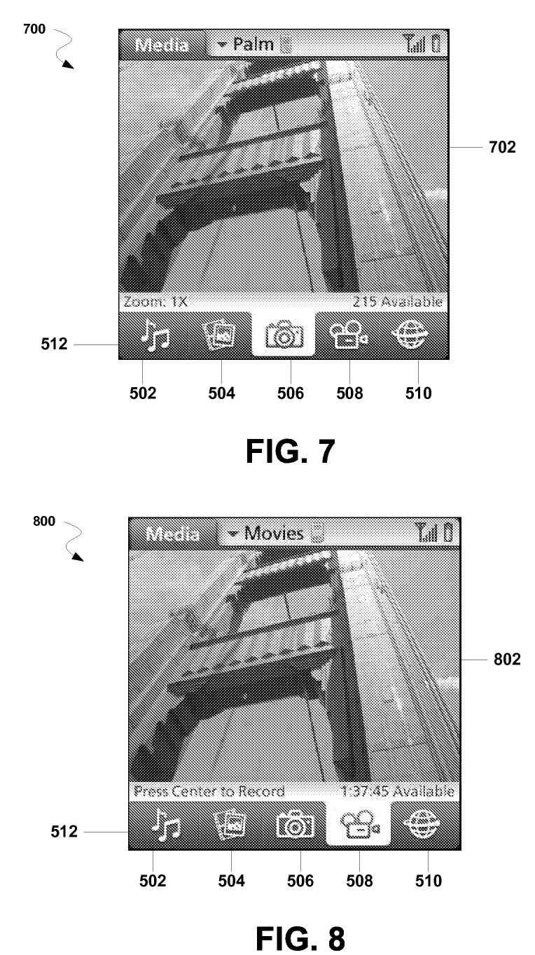

FIG. 7 illustrates one embodiment of a tabbed multimedia GUI 700. In various embodiments, tabbed multimedia GUI 700 may be implemented by mobile computing device 100 to enable a user to navigate to media content and/or perform available operations associated with media content. In one exemplary embodiment, tabbed multimedia GUI 700 may comprise a plurality of navigation tabs including an audio navigation tab 502, a pictures and videos navigation tab 504, a still camera navigation tab 506, a video camera navigation tab 508, and an online and bookmarks navigation tab 510.

As shown, the plurality of navigation tabs may be implemented by a navigation bar 512 located at the bottom of GUI 700. When a particular navigation tab from navigation bar 512 is selected or active, a corresponding view is displayed which is associated with the particular navigation tab. Navigation bar 512 allows the user to quickly navigate to media content and/or functions associated with other navigation tabs by tapping a different navigation tab and/or by inputting directional commands.

In FIG. 7, still camera navigation tab 506 is selected or active. Accordingly, tabbed multimedia GUI 700 may display a view allowing a user to create digital photographs using mobile computing device 100. For example, tabbed multimedia GUI 700 may operate in conjunction with a camera application to allow a user to create digital photographs using mobile computing device 100. In some embodiments, tabbed multimedia GUI 700 GUI may be the default view such that when a multimedia application launches, the camera activates and a user can immediately take a digital photograph.

In one exemplary embodiment, tabbed multimedia GUI 700 displays a viewing area 702 that shows a view which can be captured as a digital photograph. In this embodiment, input of a select command (e.g., via center key 122-5) results in taking a digital photograph of the view. It is noted that the digital photograph may be created and stored locally on mobile computing device 100 and/or a memory card (e.g., SD card, MMC, etc.) as well as stored remotely on a server or other media device. In some cases, after taking a digital photograph, a user may immediately select pictures and videos tab 504 on navigation bar 512 to allow the user to quickly display, share, upload/download, transfer, and/or manage the recently taken digital photograph.

FIG. 8 illustrates one embodiment of a tabbed multimedia GUI 800. In various embodiments, tabbed multimedia GUI 800 may be implemented by mobile computing device 100 to enable a user to navigate to media content and/or perform available operations associated with media content. In one exemplary embodiment, tabbed multimedia GUI 800 may comprise a plurality of navigation tabs including an audio navigation tab 502, a pictures and videos navigation tab 504, a still camera navigation tab 506, a video camera navigation tab 508, and an online and bookmarks navigation tab 510.

As shown, the plurality of navigation tabs may be implemented by a navigation bar 512 located at the bottom of GUI 800. When a particular navigation tab from navigation bar 512 is selected or active, a corresponding view is displayed which is associated with the particular navigation tab. Navigation bar 512 allows the user to quickly navigate to media content and/or functions associated with other navigation tabs by tapping a different navigation tab and/or by inputting directional commands.

In FIG. 8, video camera navigation tab 506 is selected or active. Accordingly, tabbed multimedia GUI 700 may display a view allowing a user to create video movies using mobile computing device 100. For example, tabbed multimedia GUI 700 may operate in conjunction with a camera application to allow a user to video movies using mobile computing device 100.

In one exemplary embodiment, tabbed multimedia GUI 800 displays a viewing area 802 that shows a view which can be captured as a video movie. In this embodiment, input of a select command (e.g., via center key 122-5) results in taking a video movie of the view. It is noted that the video movie may be created and stored locally on mobile computing device 100 and/or a memory card (e.g., SD card, MMC, etc.) as well as stored remotely on a server or other media device. In some cases, after taking a video movie, a user may immediately select pictures and videos navigation tab 504 on navigation bar 512 to allow the user to quickly display, share, upload/download, transfer, and/or manage the recently taken video movie.

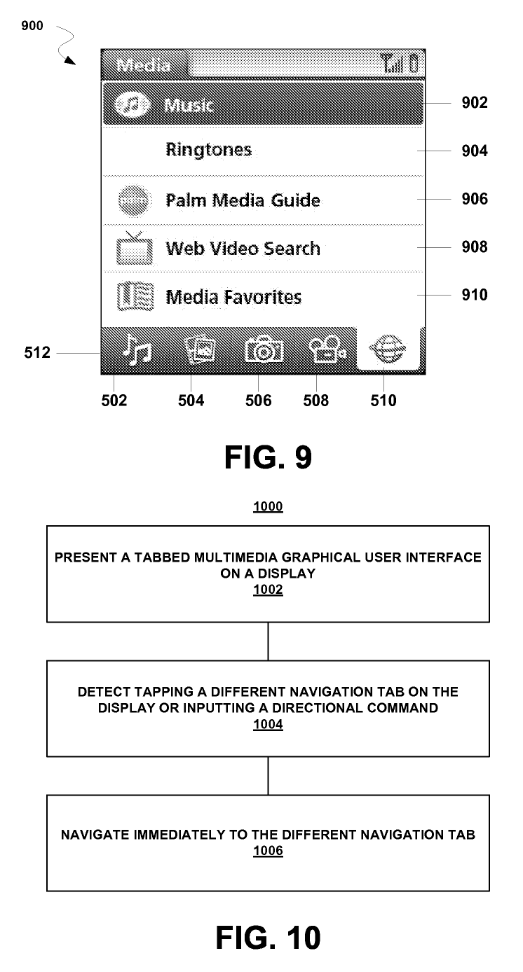

FIG. 9 illustrates one embodiment of a tabbed multimedia GUI 900. In various embodiments, tabbed multimedia GUI 900 may be implemented by mobile computing device 100 to enable a user to navigate to media content and/or perform available operations associated with media content. In one exemplary embodiment, tabbed multimedia GUI 900 may comprise a plurality of navigation tabs including an audio navigation tab 502, a pictures and videos navigation tab 504, a still camera navigation tab 506, a video camera navigation tab 508, and an online and bookmarks navigation tab 510.

As shown, the plurality of navigation tabs may be implemented by a navigation bar 512 located at the bottom of GUI 900. When a particular navigation tab from navigation bar 512 is selected or active, a corresponding view is displayed which is associated with the particular navigation tab. Navigation bar 512 allows the user to quickly navigate to media content and/or functions associated with other navigation tabs by tapping a different navigation tab and/or by inputting directional commands.

In FIG. 9, online and bookmarks navigation tab 504 is selected or active. Accordingly, tabbed multimedia GUI 900 displays various menu items for navigating to and/or performing available operations associated with online media content. For example, tabbed multimedia GUI 900 may provide menu items for enabling a user to manage, browse, and display online content available through a variety of online media channels and/or services.

In one exemplary embodiment, tabbed multimedia GUI 900 displays a music menu item 902, a ring tones menu item 904, a media guide menu item 906, a Web video search menu item 908, and a media favorites menu item 910. In some embodiments, each subsequent GUI presented after selection of a particular menu item also may comprise navigation bar 512 to allow the user to quickly navigate to media content and/or functions associated with other navigation tabs.

When music menu item 902 is selected, a subsequent GUI may be displayed providing access to one or more online music channels and/or services. In some cases, the online music channels and/or services may be provided by and/or associated with an entity having a business relationship with the manufacturer of mobile computing device 100 and/or the communications services carrier for mobile computing device 100.

When ring tones menu item 904 is selected, a subsequent GUI may be displayed providing access to one or more online channels and/or services for downloading ring tones to mobile computing device 100. In some cases, the online ring tone channels and/or services may be provided by and/or associated with an entity having a business relationship with the manufacturer of mobile computing device 100 and/or the communications services carrier for mobile computing device 100.

When media guide menu item 906 is selected, a subsequent GUI may be displayed providing access to one or more online media channels and/or services provided by and/or associated with the manufacturer of mobile computing device 100.

When Web video search menu item 908 is selected, a subsequent GUI may be displayed providing access to a Web searching and sharing service provided by and/or associated with an entity having a business relationship with the manufacturer of mobile computing device 100.

When media favorites menu item 910 is selected, a subsequent GUI may be displayed providing access to one or more online media services subscribed to by the user of mobile computing device 100 and/or designated by the user as a favorite.

It is noted that various types of menu items may be provided by tabbed multimedia GUI 900 to enable access to a variety of online media channels and/or services such as audio and/or video streaming, audio downloads for ring tones and/or music, picture and/or video downloads, audio and/or video podcasts, online communities for sharing media content, Web video searching and sharing, digital photograph searching and sharing, Internet radio and/or television stations, RSS feeds, blogs, and others.

FIG. 10 illustrates one embodiment of a logic flow 1000. In various embodiments, logic flow 1000 may be performed by various systems and/or devices and may be implemented as hardware, software, and/or any combination thereof, as desired for a given set of design parameters. For example, logic flow 1000 may be implemented by a logic device (e.g., computer, processor) and/or logic (e.g., executable computer program instructions) to be executed by a logic device.

Logic flow 1000 may comprise presenting a tabbed multimedia graphical user interface on a display (block 1002). In various embodiments, the tabbed multimedia graphical user interface may comprise a navigation bar including a plurality of navigation tabs for navigating to media content and performing available operations associated with the media content. The tabbed multimedia graphical user interface may present a corresponding view associated with an active navigation tab.

Logic flow 1000 may further comprise detecting at least one of tapping a different navigation tab on the display and inputting a directional command to the mobile computing device (block 1004) and navigating immediately to the different navigation tab (block 1006). The different navigation tab may present the corresponding view for enabling a user to navigate to media content and perform available operations associated with the different navigation tab.

As described and illustrated above, the plurality of navigation tabs may comprise an audio navigation tab associated with audio content, a pictures and videos navigation tab associated with image and video content, a still camera navigation tab for taking digital photographs, a video camera navigation tab for taking video movies, and an online and bookmarks navigation tab associated with online media content. In various implementations, left and right commands are dedicated for navigation among the navigation tabs, and up and down commands are dedicated for navigation within the active navigation tab.

In various embodiments, logic flow 1000 may comprise, or be implemented as, executable computer program instructions. The executable computer program instructions may be implemented by software, a software module, an application, a program, a subroutine, instructions, an instruction set, computing code, words, values, symbols or combination thereof. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The executable computer program instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

In various embodiments, logic flow 100 may comprise, or be implemented as, executable computer program instructions stored in an article of manufacture and/or computer-readable storage medium. The article and/or computer-readable storage medium may store executable computer program instructions that, when executed by a computer, cause the computer to perform methods and/or operations in accordance with the described embodiments. The article and/or computer-readable storage medium may be implemented by various systems and/or devices in accordance with the described embodiments.

The article and/or computer-readable storage medium may comprise one or more types of computer-readable storage media capable of storing data, including volatile memory or, non-volatile memory, removable or non-removable memory, erasable or non-erasable memory, writeable or re-writeable memory, and so forth. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other suitable type of computer-readable media in accordance with the described embodiments.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

Although some embodiments may be illustrated and described as comprising exemplary functional components or modules performing various operations, it can be appreciated that such components or modules may be implemented by one or more hardware components, software components, and/or combination thereof.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a computer, or any combination thereof.

Some embodiments may be implemented as an article of manufacture comprising a computer-readable storage medium to store executable computer program instructions for performing various operations as described herein. In such embodiments, a computer may include any suitable computer platform, device, system, or the like implemented using any suitable combination of hardware and/or software.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, API, exchanging messages, and so forth.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A mobile computing device, comprising:
a display to present a tabbed multimedia graphical user interface comprising a navigation bar including a plurality of navigation tabs for navigating to media content and performing available operations associated with the media content, the tabbed multimedia graphical user interface to present a corresponding view associated with an active navigation tab,
wherein tapping a different navigation tab on the display or inputting a directional command to the mobile computing device immediately navigates to the different navigation tab and presents the corresponding view to enable a user to navigate to media content and perform available operations associated with the different navigation tab.

2. The mobile computing device of claim 1, the plurality of navigation tabs comprising:
an audio navigation tab associated with audio content;
a pictures and videos navigation tab associated with image and video content;
a still camera navigation tab for taking digital photographs;
a video camera navigation tab for taking video movies; and
an online and bookmarks navigation tab associated with online media content.

3. The mobile computing device of claim 1, the active navigation tab for navigating to and performing operations associated with media content stored locally on the mobile computing device.

4. The mobile computing device of claim 1, the active navigation tab for navigating to and performing operations associated with media content stored on memory card.

5. The mobile computing device of claim 1, the active navigation tab for navigating to and performing operations associated with online media content.

6. The mobile computing device of claim 1, the active navigation tab for transferring media content between the mobile computing device and a local media device.

7. The mobile computing device of claim 1, wherein input of a left command to the mobile computing device navigates to a previous navigation tab, and input of a right command to the mobile computing device navigates to a next navigation tab.

8. The mobile computing device of claim 7, wherein input of a right command when at a far right navigation tab navigates to a far left navigation tab, and input of a left command when at a far left navigation tab navigates to the far right navigation tab.

9. The mobile computing device of claim 1, wherein up and down commands are dedicated for navigation within the active navigation tab.

10. The mobile computing device of claim 1, wherein the corresponding view associated with the active navigation tab comprises a plurality of menu items associated with the particular navigation tab.

11. The mobile computing device of claim 10, wherein up and down commands are dedicated for moving among the menu items.

12. The mobile computing device of claim 11, wherein tapping a menu item on the display or inputting a select command chooses a selected menu item.

13. The mobile computing device of claim 12, wherein a subsequent graphical user interface presented in response to a selected menu item comprises the navigation bar.

14. The mobile computing device of claim 1, further comprising a navigation button to input left, right, up, down, and select commands.

15. A method comprising:
presenting a tabbed multimedia graphical user interface on a display, the tabbed multimedia graphical user interface comprising a navigation bar including a plurality of navigation tabs for navigating to media content and performing available operations associated with the media content, the tabbed multimedia graphical user interface to present a corresponding view associated with an active navigation tab;
detecting at least one of tapping a different navigation tab on the display and inputting a directional command to the mobile computing device; and
navigating immediately to the different navigation tab to present the corresponding view for enabling a user to navigate to media content and perform available operations associated with the different navigation tab.

16. The method of claim 15, the plurality of navigation tabs comprising:
an audio navigation tab associated with audio content;
a pictures and videos navigation tab associated with image and video content;
a still camera navigation tab for taking digital photographs;
a video camera navigation tab for taking video movies; and
an online and bookmarks navigation tab associated with online media content.

17. The method of claim 15, wherein left and right commands are dedicated for navigation among the navigation tabs and up and down commands are dedicated for navigation within the active navigation tab.

18. An article of manufacture comprising a computer-readable storage medium storing executable computer program instructions that when executed by a computer cause the computer to:
present a tabbed multimedia graphical user interface on a display, the tabbed multimedia graphical user interface comprising a navigation bar including a plurality of navigation tabs for navigating to media content and performing available operations associated with the media content, the tabbed multimedia graphical user interface to present a corresponding view associated with an active navigation tab;
detect at least one of tapping a different navigation tab on the display and inputting a directional command to the mobile computing device; and
navigate immediately to the different navigation tab to present the corresponding view for enabling a user to navigate to media content and perform available operations associated with the different navigation tab.

19. The article of claim 18, the plurality of navigation tabs comprising:
an audio navigation tab associated with audio content;
a pictures and videos navigation tab associated with image and video content;
a still camera navigation tab for taking digital photographs;
a video camera navigation tab for taking video movies; and
an online and bookmarks navigation tab associated with online media content.

20. The article of claim 18, wherein left and right commands are dedicated for navigation among the navigation tabs and up and down commands are dedicated for navigation within the active navigation tab.
